(19) United States
(12) Patent Application Publication
(10) Pub. No.: US 2005/0165677 A1
(43) Pub. Date: Jul. 28, 2005

(54) Method of increasing a realized portion of periodically-paid monetary payments

(75) Inventor: Stephen Drake, Prescott, AZ (US)

Correspondence Address: Kenneth A. Nelson;Bryan Cave LLP, Suite 2200, Two North Central Avenue, Phoenix, AZ, 85004-4406, US

(73) Assignee: Benecorp, LLC, Prescott, AZ (US)

(21) Appl. No.: 10/763,796

(22) Filed: Jan. 22, 2004

(51) Int. Cl. G06F 17/60

(52) U.S. Cl. 705/40

(57) ABSTRACT

A method of increasing a realized portion of a plurality of monetary payments includes: creating a deferred income account; identifying a payout amount; receiving into the deferred income account a deferred portion of a first one of the plurality of monetary payments; after receiving the deferred portion of the first one of the plurality of monetary payments, optionally deducting an expense amount from the deferred income account; after receiving the deferred portion of the first one of the plurality of monetary payments, providing a first portion of the deferred income account for obtaining the payout amount; and repeating the receiving and deducting steps for subsequent ones of the plurality of monetary payments. After an occurrence of a qualifying event, the payout amount and a balance of the deferred income account are distributed to one or more qualifying recipients.

### FIELD OF THE INVENTION

This invention relates generally to financial planning, and relates more particularly to deferred compensation arrangements.

### BACKGROUND OF THE INVENTION

Tax structures in place in many jurisdictions are progressive, meaning that they tax larger amounts at higher rates. Highly compensated individuals, high-income entities, and others subject to high tax rates may be able to realize, or retain, a larger portion of their income, or pass a larger portion of their income to their beneficiaries, if they arrange their finances with the tax consequences of such financial arrangements in mind. For example, due to a variety of tax rules and/or regulations, deferring a portion of current income may allow future realization of an amount greater than the amount that could be realized if no income had been deferred.

Certain individuals and other entities receive regular, periodic payments for reasons other than work performed for an employer. Such individuals and other entities are often members of a group of similarly-situated individuals or entities. The regular, periodic payments can at times be large enough to subject such individuals and other entities to taxes at a level that a tax-reducing financial arrangement becomes desirable. Accordingly, there exists a need for a method of increasing a realized portion of periodically-received monetary payments that can be used by individuals and other entities receiving the periodically-received monetary payments for reasons other than work performed for an employer.

### BRIEF DESCRIPTION OF THE DRAWINGS

The invention will be better understood from a reading of the following detailed description, taken in conjunction with the accompanying figures in the drawings in which:

FIG. 1 is a flow chart illustrating a method of increasing a realized portion of a plurality of monetary payments that are to be paid on a periodic basis by a first entity to a second entity;

FIG. 2 is a flow chart illustrating a method of reducing a tax obligation owed by a tribal member on a plurality of monetary payments that are to be paid on a periodic basis to the tribal member by the tribal member's Indian Tribe; and

FIG. 3 is a flow chart illustrating a method of increasing a realized portion of a plurality of monetary payments that are to be periodically paid by an Indian Tribe to a tribal member of the Indian Tribe as a result of a birthright of the tribal member.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical, mechanical, or other manner.

### DETAILED DESCRIPTION OF THE DRAWINGS

In one embodiment of the invention, a method of increasing a realized portion of a plurality of monetary payments that are to be paid on a periodic basis by a first entity to a second entity comprises: creating a deferred income account; identifying a payout amount for the second entity; receiving into the deferred income account a deferred portion of a first one of the plurality of monetary payments in order to increase a balance of the deferred income account; after receiving the deferred portion of the first one of the plurality of monetary payments, deducting an expense amount from the balance of the deferred income account; after receiving the deferred portion of the first one of the plurality of monetary payments, providing a first portion of the balance of the deferred income account for obtaining the payout amount; and repeating the receiving and deducting steps for subsequent ones of the plurality of monetary payments. After an occurrence of a qualifying event, the payout amount is distributed to at least one of the second entity and one or more entities designated by the second entity, and the balance of the deferred income account is distributed to at least one of the second entity and the one or more entities designated by the second entity.

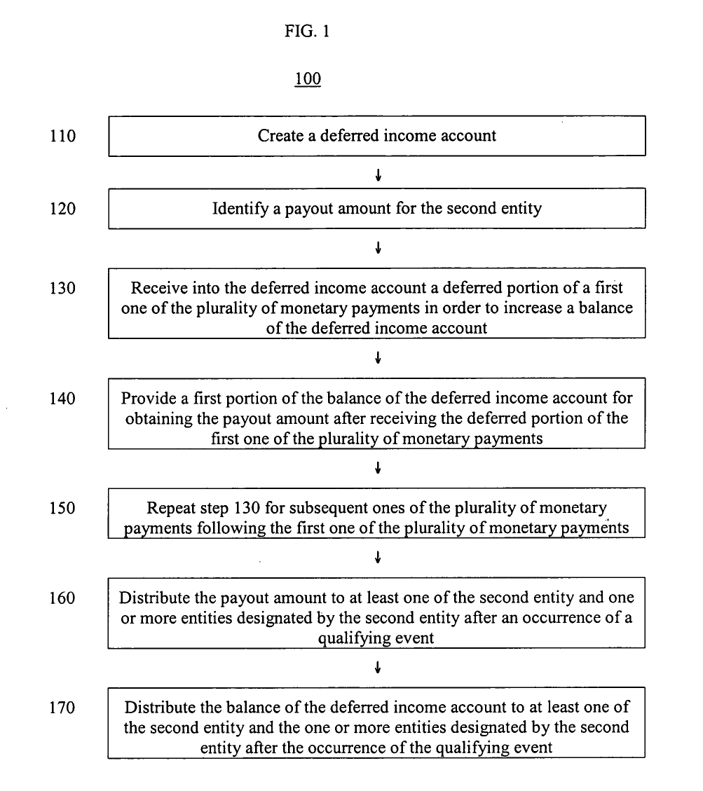

FIG. 1 is a flowchart illustrating a method 100 of increasing a realized portion of a plurality of monetary payments that are to be paid on a periodic basis by a first entity to a second entity. As an example, each one of the plurality of monetary payments can be a per capita distribution paid by an Indian Tribe to each member of the Indian Tribe, referred to herein as tribal members. Tribal members can be entitled to the per capita distributions as a result of a birthright of the tribal member, meaning that simply being born into the Indian Tribe entitles the tribal member to participate equally with each other member of the Indian Tribe in the revenues of the Indian Tribe. Thus, in one embodiment, a tribal member receives per capital distributions beginning at birth.

The per capita distributions can be paid to the tribal members by the Indian Tribe on a monthly, quarterly, yearly, or other periodic basis. As an example, the per capita distributions can comprise a distribution from net revenues, which in at least one embodiment are divided equally among all tribal members, of one or more income-producing operations of the Indian Tribe. As an example, the income-producing operations can comprise at least one of a gaming operation of the tribe, a media, banking, or other commercial operation of the Indian Tribe, a sale or lease by the Indian Tribe of water, land, oil, timber, coal, sand, gravel, or the like, or rights to use any of the foregoing.

As an example, the realized portion can be that portion of the plurality of monetary payments that the second entity, or one or more beneficiaries of the second entity, actually receives after satisfying all tax obligations incurred as a result of the receipt of the plurality of monetary payments. As still another example, the first entity and/or the second entity can be an individual, or a for-profit or non-profit trust, partnership, company, or the like.

A step 110 of method 100 is to create a deferred income account. In one embodiment, the deferred income account is held in a trust. In a different embodiment, the deferred income account is not within a trust.

A step 120 of method 100 is to identify a payout amount for the second entity. As an example, the payout amount can be a monetary amount that the second entity and/or one or more entities designated by the second entity are guaranteed to receive upon the satisfaction or occurrence of one or more qualifying events. As another example, the payout amount can be offered by an administrator of method 100 as an inducement to participation in method 100. In one embodiment, the payout amount is a constant amount, and in another embodiment, the payout amount can change based upon one or more factors such as a length of time the second entity participates in method 100, prevailing interest rates, or the like.

A step 130 of method 100 is to receive into the deferred income account a deferred portion of a first one of the plurality of monetary payments in order to increase a balance of the deferred income account. As an example, the deferred portion can comprise any portion of the first one of the plurality of monetary payments that the second entity wishes to defer. Once the deferred portion is received into the deferred income account, it is not accessible to the second entity and is therefore not taxed until it is distributed from the deferred income account. Deferring the deferred portion in this manner thus can reduce a tax obligation of the second entity.

For each one of the plurality of monetary payments, a difference between the total amount of the monetary payment and the deferred portion is referred to herein as a non-deferred portion for that particular monetary payment. In one embodiment, each non-deferred portion is paid to the second entity when the first entity pays the monetary payment of which the non-deferred portion is a part.

One of ordinary skill in the art will understand that an amount for a monetary payment and amounts for a deferred and a non-deferred portion of the monetary payment can be varied virtually without limit, with the only limitation being that the non-deferred portion is equal to the difference between the monetary payment and the deferred portion. However, as one particular example, given for illustrative purposes only, a monetary payment may be in the amount of $200,000, a deferred portion for the monetary payment may be in the amount of $165,000, and a non-deferred portion for the monetary payment may therefore be in the amount of $35,000. In this particular example, and assuming a progressive tax structure such as has been in place in the United States for at least several decades, where higher marginal income is taxed at higher rates, the $200,000 monetary payment as a whole might be subject to an average tax rate of approximately 35 percent. Accordingly, if no portion of the monetary payment is deferred, thus leaving the entire monetary payment subject to a tax, approximately $70,000 of the $200,000 monetary payment would need to be paid as current taxes. Of course, the $165,000 deferred portion is subject to a future tax, to be paid when the deferred portion is actually received, whether by the second entity, by one or more entities designated by the second entity, or by another entity. However, as is well known in the art, it is often beneficial to defer taxes to a future date. Deferring the $165,000 deferred portion to the deferred income account means that the deferred portion, as well as the balance of the deferred income account, are not subject to a current tax. In other words, during a time at which step 130 occurs, neither the deferred portion nor the balance of the deferred income account are subject to a tax. As alluded to above, the balance of the deferred income account will be subject to a tax at some future time, when that balance is paid out or distributed.

On the other hand, to continue the particular example of the preceding paragraph, the $35,000 that is kept, after deferring $165,000, may be subject to an average tax rate of approximately 15 percent, meaning that only approximately $5,000 of the monetary payment would need to be paid as current taxes. Thus, deferring $165,000 to a deferred income account in the manner of step 130 allows the second entity to save approximately $30,000 in current taxes.

A step 140 of method 100 is to provide a first portion of the balance of the deferred income account for obtaining the payout amount after receiving the deferred portion of the first one of the plurality of monetary payments. As an example, the first portion can be a monetary amount that is provided to third party in order that the third party may, for example, invest the first portion. A portion of a return on the investments may be used to pay the payout amount. In one embodiment, the plan administrator, rather than a third party, can be responsible for obtaining the payout amount, whether by investing the first portion or through some other method.

A step 150 of method 100 is to repeat step 130 for subsequent ones of the plurality of monetary payments following the first one of the plurality of monetary payments. As an example, participation in method 100 can be predicated upon an agreement by the second entity to designate a deferred portion of each one of the plurality of monetary payments the second entity is to receive during a given interval of time for deposit in the deferred income account. In return for such an agreement, the second entity can be guaranteed, for example, receipt of the payout amount upon the occurrence of a qualifying event. Another benefit of participation in method 100 is the possibility of a reduced tax obligation, as described in more detail above. In one embodiment, an amount of the deferred portion can be the same for each one of the plurality of monetary payments. In another embodiment, the amount of the deferred portion can differ from one monetary payment to another.

A step 160 of method 100 is to distribute the payout amount to at least one of the second entity and one or more entities designated by the second entity after an occurrence of a qualifying event. As an example, the qualifying event can be a hardship or an unforeseen emergency, the cessation of the second entity's participation in method 100, the termination of, or, in the case of an individual, the death of, the second entity, or the like. In one embodiment, “hardship” and “unforeseen emergency” can be as defined by the U.S. Internal Revenue Service. As a particular example, when the second entity is a tribal member, the qualifying event can occur when the tribal member's Indian Tribe chooses to end its participation in method 100, as, for example, when the Indian Tribe's income ceases to be such that participation in method 100 is beneficial. If the qualifying event is the termination of the second entity, step 160 comprises distributing the payout amount to the one or more entities designated by the second entity, and not to the second entity itself. In one embodiment, the payout amount can be distributed in a single lump sum. In another embodiment, the payout amount can be distributed in multiple periodic payments.

A step 170 of method 100 is to distribute the balance of the deferred income account to at least one of the second entity and the one or more entities designated by the second entity after the occurrence of the qualifying event. Like the payout amount, the balance of the deferred income account can be distributed in a single lump sum or in a plurality of periodic payments. As will be understood by one of ordinary skill in the art, the balance of the deferred income account, whether distributed in a lump sum or in periodic payments, will ordinarily be subject to a tax. At the same time, in at least one embodiment, neither the plurality of monetary payments nor the balance of the deferred income account distributed to the at least one of the second entity and the one or more entities designated by the second entity will be subject to an employment tax.

In one embodiment of method 100, the first entity and the second entity do not have an employer-employee relationship during a time at which step 130 occurs. In the same or another embodiment, the second entity does not receive any portion of any of the plurality of monetary payments in exchange for work performed for the first entity during a time at which the receiving and deducting steps occur.

In the same or another embodiment of method 100, a first optional step of method 100 is to advise the second entity regarding a value or monetary amount of one or more of the deferred portions. As an example, such advice can be designed to assist the second entity in maximizing an advantage realized by participation in method 100, and can include, for example, advice regarding tax consequences of various values or monetary amounts of the one or more of the deferred portions.

In the same or another embodiment of method 100, a second optional step of method 100 is to invest an investment portion of the deferred income account on behalf on the second entity. As an example, the investment portion can be different from the first portion of the balance of the deferred income account mentioned above in connection with step 140 and used for obtaining the payout amount. The investment portion can be invested in any appropriate financial instrument in order to produce a return for the second entity.

In the same or another embodiment of method 100, a third optional step of method 100 is to arrange a loan for a principal amount to the second entity. In one embodiment, the plan administrator can make the loan. In a second embodiment, the plan administrator can invest funds with a third party, with the third party making the loan in return for the investment. In this second embodiment, the third party can work with an outside insurer to obtain insurance on the second entity, assumed for this example to be a tribal member, and when the tribal member dies the third party can return an agreed-upon sum of money to the plan administrator. Other arrangements are also possible, as will be recognized by one of ordinary skill in the art. For example, the first entity itself can make the loan to the second entity.

As an example, the second entity, having deferred a deferred portion of a particular one of the plurality of monetary payments, may not be able to operate as desired using only the non-deferred portion of the particular one of the plurality of monetary payments. Accordingly, the second entity may obtain a loan in order to increase cash flow. In one embodiment, the loan amount and the deferred amount can be such that more money is saved in current taxes than is owed as an interest payment amount to repay a finance charge for the loan. In the same or another embodiment, the third optional step or another optional step comprises periodically withholding the interest payment amount from the balance of the deferred income account to repay the finance charge for the loan.

As an example, the loan can comprise a revolving line of credit. In one embodiment, the revolving line of credit is a credit line where interest is not accrued but is paid currently by the borrower, which in this case is the second entity. In another embodiment, the borrower can make periodic interest payments in a manner similar to interest payments made on a conventional loan. In yet another embodiment, interest payments currently due and/or interest payments that will be due in the future can be withheld from the deferred income account. As another example, the loan can be a secured loan, an unsecured loan, an equity line of credit, or any similar financial instrument. In a particular embodiment, the loan is not secured by the deferred income account. In the same or another embodiment, the loan is secured using at least one of the non-deferred portions of the plurality of monetary payments that has not been paid by the first entity to the second entity at a time when the loan is made. In another embodiment, assets owned by the first entity and/or the second entity can be used as collateral for the loan. As will be recognized by one of ordinary skill in the art, the lender, whether the administrator of method 100 or another entity, can make the loan based on reasonable business parameters, including the financial wherewithal of the second entity beyond the plurality of monetary payments.

In the same or another embodiment of method 100, a fourth optional step of method 100 is to deduct an expense amount from the balance of the deferred income account after receiving the deferred portion of the first one of the plurality of monetary payments. As an example, the expense amount can be a monetary amount representing a fee charged by the administrator of method 100 for the administration of method 100.

In one embodiment, method 100 is governed by rules promulgated under the authority of one or more of the first entity, a federal Indian Gaming Regulatory Act, a United States Bureau of Indian Affairs, a United States Department of the Interior, a state compact, or the like. A state compact is defined herein as a state-issued or state-created statute, document, agreement, or the like affecting the state's treatment of the second entity. As an example, the state compact can be particularly relevant when the first entity is an Indian Tribe and the second entity is a tribal member. More than one state compact may govern method 100. It will be understood by one of ordinary skill in the art that, in one embodiment, the first entity itself can own any insurance or other investments on behalf of the second entity.

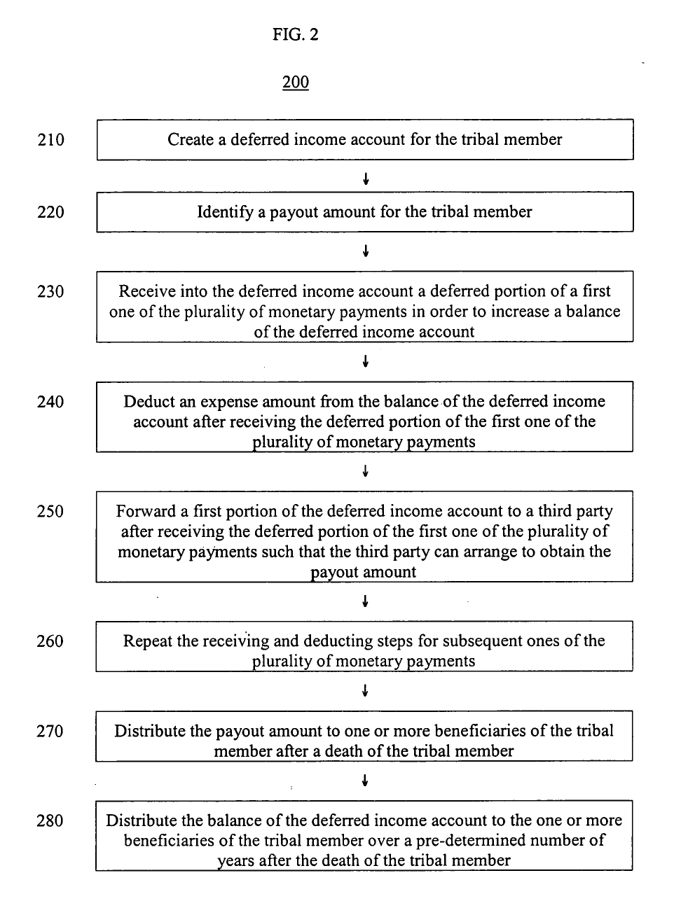

FIG. 2 is a flow chart illustrating a method 200 of reducing a tax obligation owed by a tribal member on a plurality of monetary payments that are to be paid on a periodic basis to the tribal member by the tribal member's Indian Tribe, where the tribal member is entitled to the monetary payment as a result of a birthright of the tribal member. As an example, the plurality of monetary payments can be similar to the plurality of monetary payments introduced in method 100.

A step 210 of method 200 is to create a deferred income account for the tribal member. As an example, the deferred income account can be similar to the deferred income account created in step 110 of method 100.

A step 220 of method 200 is to identify a payout amount for the tribal member. As an example, the payout amount can be similar to the payout amount identified in step 120 of method 100.

A step 230 of method 200 is to receive into the deferred income account a deferred portion of a first one of the plurality of monetary payments in order to increase a balance of the deferred income account. As an example, the deferred portion can be similar to the deferred portion received in step 130 of method 100. In at least one embodiment, the deferred portion is received into the deferred income account substantially simultaneously with a payment by the Indian Tribe of the first one of the plurality of monetary payments.

A step 240 of method 200 is to deduct an expense amount from the balance of the deferred income account after receiving the deferred portion of the first one of the plurality of monetary payments. In an alternate embodiment, an expense amount is not deducted from the balance of the deferred income account.

A step 250 of method 200 is to forward a first portion of the deferred income account to a third party after receiving the deferred portion of the first one of the plurality of monetary payments such that the third party can arrange to obtain the payout amount. As an example, the first portion can be similar to the first portion provided in step 150 of method 100.

A step 260 of method 200 is to repeat the receiving and deducting steps for subsequent ones of the plurality of monetary payments.

A step 270 of method 200 is to distribute the payout amount to one or more beneficiaries of the tribal member after a death of the tribal member. In one embodiment, the payout amount can be distributed in a single lump sum. In another embodiment, the payout amount can be distributed in multiple periodic payments.

A step 280 of method 200 is to distribute the balance of the deferred income account to the one or more beneficiaries of the tribal member over a predetermined number of years after the death of the tribal member. As an example, the balance of the deferred income account can be distributed over a 20 or 30 year period.

In one embodiment of method 200, the third party makes a loan for a principal amount to the tribal member. As an example, the loan can be similar to the loan described in the third optional step of method 100. As an example, in the embodiment of method 200 described in this paragraph, the third party can periodically withhold an interest payment amount from the balance of the deferred income account to repay a finance charge for the loan.

In one manifestation of the embodiment described in the preceding paragraph, at least a portion of the principal amount, and in one embodiment the entire principal amount, is paid after the death of the tribal member out of a death benefit of an insurance policy on the life of the tribal member. In another manifestation of the embodiment, the death benefit is paid out of other assets besides the death benefit of an insurance policy.

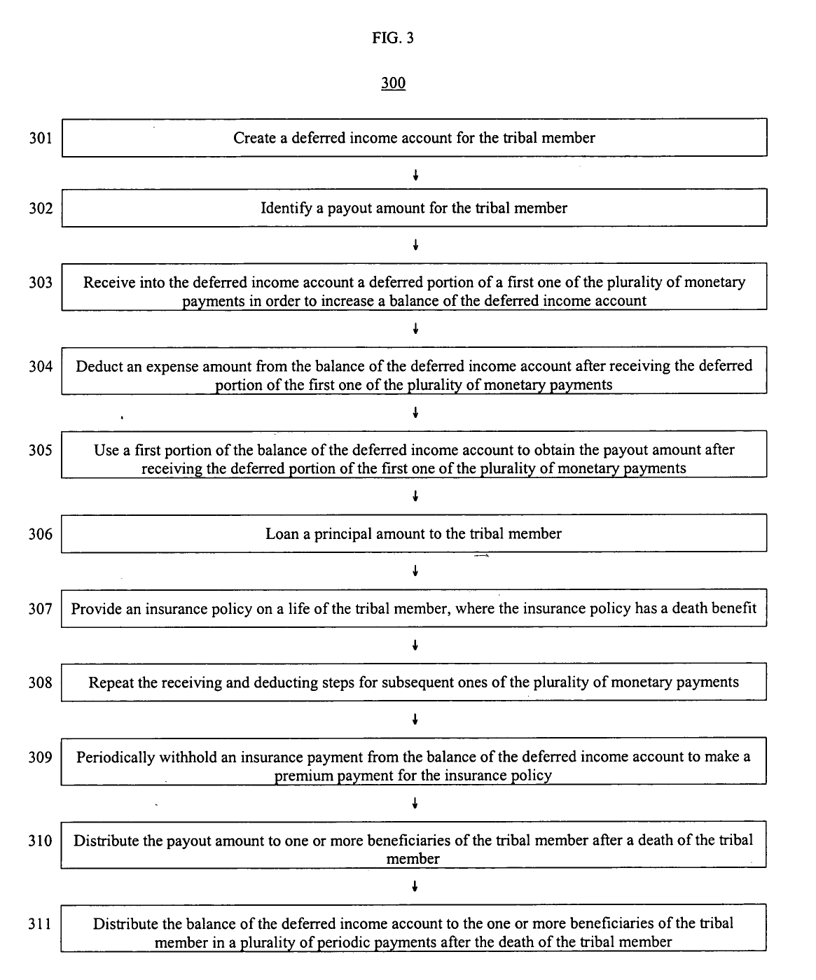

FIG. 3 is a flowchart illustrating a method 300 of increasing a realized portion of a plurality of monetary payments that are to be periodically paid by an Indian Tribe to a tribal member of the Indian Tribe as a result of a birthright of the tribal member. As an example, the plurality of monetary payments can be similar to the plurality of monetary payments introduced in method 100.

A step 301 of method 300 is to create a deferred income account for the tribal member. As an example, the deferred income account can be similar to the deferred income account created in step 110 of method 100.

A step 302 of method 300 is to identify a payout amount for the tribal member. As an example, the payout amount can be similar to the payout amount identified in step 120 of method 100.

A step 303 of method 300 is to receive into the deferred income account a deferred portion of a first one of the plurality of monetary payments in order to increase a balance of the deferred income account. As an example, the deferred portion can be similar to the deferred portion received in step 130 of method 100. In at least one embodiment, the deferred portion is received into the deferred income account substantially simultaneously with a payment by the Indian Tribe of the first one of the plurality of monetary payments.

A step 304 of method 300 is to deduct an expense amount from the balance of the deferred income account after receiving the deferred portion of the first one of the plurality of monetary payments. As an example, the expense amount can be similar to the expense amount deducted in step 240 of method 200. In an alternate embodiment, an expense amount is not deducted from the balance of the deferred income account.

A step 305 of method 300 is to use a first portion of the balance of the deferred income account to obtain the payout amount after receiving the deferred portion of the first one of the plurality of monetary payments. As an example, the first portion can be similar to the first portion provided in step 150 of method 100.

A step 306 of method 300 is to loan a principal amount to the tribal member. As an example, the loan can be similar to the loan described in the third optional step of method 100. As another example, the principal amount can be a second portion of the balance of the deferred income account.

A step 307 of method 300 is to provide an insurance policy on a life of the tribal member, where the insurance policy has a death benefit. As an example, the insurance policy can be similar to the insurance policy introduced in connection with method 200, above.

A step 308 of method 300 is to repeat the receiving and deducting steps for subsequent ones of the plurality of monetary payments.

A step 309 of method 300 is to periodically withhold an insurance payment from the balance of the deferred income account to make a premium payment for the insurance policy. In an alternate embodiment, step 309 can be performed by a third party instead of by the plan administrator.

A step 310 of method 300 is to distribute the payout amount to one or more beneficiaries of the tribal member after a death of the tribal member. In one embodiment, the payout amount can be distributed in a single lump sum. In another embodiment, the payout amount can be distributed in multiple periodic payments.

A step 311 of method 300 is to distribute the balance of the deferred income account to the one or more beneficiaries of the tribal member in a plurality of periodic payments after the death of the tribal member. In one embodiment of method 300, step 311 or another step can comprise distributing a qualified portion of the balance of the deferred income account to the tribal member following a request of the tribal member and provided a qualified event has occurred. The term “qualified event” is used here to distinguish an event that may trigger distribution of the qualified portion to the tribal member from those events, introduced in connection with method 100 and called “qualifying events” herein, that may trigger a distribution of the payout amount to at least one of the second entity and one or more entities designated by the second entity and/or a distribution of the balance of the deferred income account to at least one of the second entity and the one or more entities designated by the second entity.

A qualified event is defined herein as a hardship or unforeseen emergency, as those terms are described above, or the like. Accordingly, a qualified event, as defined herein, may also be a qualifying event, but the reverse is not necessarily true. For example, the death of the tribal member would not be a qualified event herein, although it may be a qualifying event, as described above.

Method 300 can optionally further comprise one or more of: investing a third portion of the balance of the deferred income account on behalf of the tribal member; and advising the tribal member regarding a value or monetary amount of one or more of the deferred portions, including advising the tribal member regarding tax consequences of various values or monetary amounts of the one or more of the deferred portions.

Although the invention has been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the method of increasing a realized portion of periodically-paid monetary payments discussed herein may be implemented in a variety of embodiments, and that the foregoing discussion of certain of these embodiments does not necessarily represent a complete description of all possible embodiments.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A method of increasing a realized portion of a plurality of monetary payments that are to be paid on a periodic basis by a first entity to a second entity the method comprising:
creating a deferred income account;
identifying a payout amount for the second entity;
receiving into the deferred income account a deferred portion of a first one of the plurality of monetary payments in order to increase a balance of the deferred income account;
after receiving the deferred portion of the first one of the plurality of monetary payments, providing a first portion of the balance of the deferred income account for obtaining the payout amount; and
repeating the receiving step for subsequent ones of the plurality of monetary payments,
wherein:
after an occurrence of a qualifying event, the payout amount is distributed to at least one of the second entity and one or more entities designated by the second entity; and
after the occurrence of the qualifying event, the balance of the deferred income account is distributed to at least one of the second entity and the one or more entities designated by the second entity.

2. The method of claim 1 further comprising:
after receiving the deferred portion of the first one of the plurality of monetary payments, deducting an expense amount from the balance of the deferred income account.

3. The method of claim 1 wherein:
the balance of the deferred income account and the payout amount are distributed to at least one of the second entity and one or more entities designated by the second entity in a plurality of periodic payments made to the at least one of the second entity and the one or more entities designated by the second entity.

4. The method of claim 1 wherein:
for each of the plurality of monetary payments, a difference between the monetary payment and the deferred portion is a non-deferred portion for the monetary payment;
the non-deferred portion for the monetary payment is paid to the second entity upon payment by the first entity of the monetary payment;
before a receipt into the deferred income account of the deferred portion, each of the plurality of monetary payments is subject to a first tax amount;
each of the non-deferred portions is subject to a second tax amount; and
the second tax amount is less than the first tax amount.

5. The method of claim 1 wherein:
the first entity and the second entity do not have an employer-employee relationship during a time at which the receiving and deducting steps occur.

6. The method of claim 1 wherein:
the second entity does not receive any portion of any of the plurality of monetary payments in exchange for work performed for the first entity during a time at which the receiving and deducting steps occur.

7. The method of claim 1 further comprising:
advising the second entity regarding a value of one or more of the deferred portions.

8. The method of claim 7 wherein:
advising the second entity regarding a value of one or more of the deferred portions comprises:
advising the second entity regarding tax consequences of various values of the one or more of the deferred portions.

9. The method of claim 1 further comprising:
investing an investment portion of the deferred income account.

10. The method of claim 1 further comprising:
making a loan for a principal amount to the second entity; and
periodically withholding an interest payment amount from the balance of the deferred income account to repay a finance charge for the loan.

11. The method of claim 1 further comprising:
making an investment in a third party,
wherein:
the third party makes a loan for a principal amount to the second entity.

12. The method of claim 10 wherein:
the loan comprises a revolving line of credit.

13. The method of claim 10 wherein:
the loan is not secured by the deferred income account.

14. The method of claim 13 wherein:
the loan is secured using at least one of the non-deferred portions of the plurality of monetary payments that has not been paid by the first entity to the second entity at a time when the loan is made.

15. The method of claim 1 wherein:
the balance of the deferred income account and the deferred portions received into the deferred income account are not subject to a tax during a time at which the receiving step occurs.

16. The method of claim 15 wherein:
the balance of the deferred income account distributed to the at least one of the second entity and the one or more entities designated by the second entity is subject to a tax.

17. The method of claim 16 wherein:
the plurality of monetary payments and the balance of the deferred income account distributed to the at least one of the second entity and the one or more entities designated by the second entity are not subject to an employment tax.

18. The method of claim 1 wherein:
the method is governed by rules promulgated under authority of at least one source selected from the group consisting of: the first entity; a federal Indian Gaming Regulatory Act; a United States Bureau of Indian Affairs; a United States Department of the Interior; and a state compact.

19. A method of reducing a tax obligation owed by a tribal member on a plurality of monetary payments that are to be paid on a periodic basis to the tribal member by the tribal member's Indian Tribe, the method comprising:
creating a deferred income account for the tribal member;
identifying a payout amount for the tribal member;
receiving into the deferred income account a deferred portion of a first one of the plurality of monetary payments in order to increase a balance of the deferred income account;
after receiving the deferred portion of the first one of the plurality of monetary payments, deducting an expense amount from the balance of the deferred income account;
after receiving the deferred portion of the first one of the plurality of monetary payments, forwarding a first portion of the deferred income account to a third party such that the third party can arrange to obtain the payout amount;
repeating the receiving and deducting steps for subsequent ones of the plurality of monetary payments;
after a death of the tribal member, distributing the payout amount to one or more beneficiaries of the tribal member; and
after the death of the tribal member, distributing the balance of the deferred income account to the one or more beneficiaries of the tribal member over a predetermined number of years,
wherein:
the tribal member is entitled to the monetary payment as a result of a birthright of the tribal member.

20. The method of claim 19 wherein:
for each of the plurality of monetary payments, a difference between the monetary payment and the deferred portion is a non-deferred portion for the monetary payment;
the non-deferred portion for the monetary payment is paid to the tribal member upon payment by the Indian Tribe of the monetary payment; and
for each of the plurality of monetary payments, the non-deferred portion for the monetary payment is subject to a lower tax rate than is the monetary payment.

21. The method of claim 19 wherein:
the Indian Tribe and the tribal member do not have an employer-employee relationship with each other.

22. The method of claim 19 wherein:
the plurality of monetary payments comprise a distribution from net revenues of at least one of a gaming operation of the Indian Tribe, a commercial operation of the Indian Tribe, or a sale or lease by the Indian Tribe of water, land, oil, timber, coal, sand, or gravel.

23. The method of claim 19 wherein:
the third party makes a loan for a principal amount to the tribal member.

24. The method of claim 23 wherein:
the principal amount is paid after the death of the tribal member out of a death benefit of an insurance policy on the life of the tribal member.

25. A method of increasing a realized portion of a plurality of monetary payments that are to be periodically paid by an Indian Tribe to a tribal member of the Indian Tribe as a result of a birthright of the tribal member, the method comprising:
creating a deferred income account for the tribal member;
identifying a payout amount for the tribal member;
receiving into the deferred income account a deferred portion of a first one of the plurality of monetary payments in order to increase a balance of the deferred income account;
after receiving the deferred portion of the first one of the plurality of monetary payments, deducting an expense amount from the balance of the deferred income account;
after receiving the deferred portion of the first one of the plurality of monetary payments, using a first portion of the balance of the deferred income account to obtain the payout amount;
loaning a principal amount to the tribal member;
providing an insurance policy on a life of the tribal member, the insurance policy having a death benefit;
repeating the receiving and deducting steps for subsequent ones of the plurality of monetary payments;
periodically withholding an insurance payment from the balance of the deferred income account to make a premium payment for the insurance policy;
after a death of the tribal member, distributing the payout amount to one or more beneficiaries of the tribal member; and
after the death of the tribal member, distributing the balance of the deferred income account to the one or more beneficiaries of the tribal member in a plurality of periodic payments,
wherein:
for each of the plurality of monetary payments, a difference between the monetary payment and the deferred portion is a non-deferred portion for the monetary payment;
the non-deferred portion for the monetary payment is paid to the tribal member upon payment by the Indian Tribe of the monetary payment;
for each of the plurality of monetary payments, the non-deferred portion for the monetary payment is subject to a lower tax rate than is the monetary payment; and
the principal amount of the loan is paid after the death of the tribal member out of the death benefit from the insurance policy.

26. The method of claim 25 further comprising:
if a qualified event has occurred, distributing a qualified portion of the balance of the deferred income account to the tribal member following a request of the tribal member.

27. The method of claim 26 wherein:
the principal amount is a second portion of the balance of the deferred income account.

28. The method of claim 27 wherein:
using the first portion of the balance of the deferred income account to obtain the payout amount comprises:
investing the first portion of the balance of the deferred income account.

29. The method of claim 28 further comprising:
investing a third portion of the balance of the deferred income account on behalf of the tribal member.

30. The method of claim 29 further comprising:
advising the tribal member regarding a value of one or more of the deferred portions.

31. The method of claim 30 wherein:
advising the tribal member regarding the value of one or more of the deferred portions comprises:
advising the tribal member regarding tax consequences of various values of the one or more of the deferred portions.

32. The method of claim 31 wherein:
loaning the principal amount comprises:
providing a revolving line of credit for the principal amount to the Tribal Member.

33. The method of claim 32 wherein:
the loan is not secured by the deferred income account.

34. The method of claim 33 wherein:
the loan is secured using at least one of the non-deferred portions of the plurality of monetary payments that has not been paid by the Indian Tribe to the tribal member at a time when the loan is made.

35. The method of claim 34 wherein:
the plurality of monetary payments and the balance of the deferred income account distributed to the one or more beneficiaries of the tribal member are not subject to an employment tax.

36. The method of claim 35 wherein:
the method is governed by rules promulgated under authority of at least one source selected from the group consisting of: the Indian Tribe; a federal Indian Gaming Regulatory Act; a United States Bureau of Indian Affairs; a United States Department of the Interior; and a state compact.

37. The method of claim 36 wherein:
the method is governed by a state compact.

38. The method of claim 37 wherein:
the monetary payment comprises a distribution from net revenues of a gaming operation of the Indian Tribe.

39. The method of claim 38 wherein:
the tribal member does not receive any portion of any of the plurality of monetary payments in exchange for work performed for the Indian Tribe during a time at which the receiving, deducting, and using steps occur.
